(19) United States
(12) Patent Application Publication
(10) Pub. No.: US 2025/0098721 A1
(43) Pub. Date: Mar. 27, 2025

(54) COMPOSITIONS COMPRISING AN UNMODIFIED SPECIALTY CORN STARCH

(71) Applicant: CORN PRODUCTS DEVELOPMENT, INC., WESTCHESTER, IL (US)

(72) Inventors: Sarah ANDERSON, Bridgewater, NJ (US); Douglas HANCHETT, Bridgewater, NJ (US); Matthew YURGEC, Bridgewater, NJ (US); Adrianne SPERANZA, Bridgewater, NJ (US); Suh Fang THNG, Singapore (SG); Sherlene LOW, Singapore (SG); Julika BASEDA, Hamburg (DE); Katelyn MEYLER, Bridgewater, NJ (US)

(21) Appl. No.: 18/730,911

(22) PCT Filed: Jan. 31, 2023
(86) PCT No.: PCT/US2023/061627

§ 371 Date: Jul. 22, 2024

Related U.S. Application Data
(60) Provisional application No. 63/305,343, filed on Feb. 1, 2022.
(60) Provisional application No. 63/319,967, filed on Mar. 15, 2022.

(51) Int. Cl. A23L 29/212; A23C 9/154; A23C 19/09; A23C 20/00

(52) U.S. Cl. CPC A23L 29/212; A23C 9/1544; A23C 19/09; A23C 20/00

(57) ABSTRACT

Use of an unmodified specialty corn starch obtained from a corn endosperm having three copies of the recessive waxy gene (wx) and two copies of the recessive amylose extender gene (ae). The starch is useful in food compositions. The composition comprises an unmodified aewx corn starch in an amount about 0.1% (wt. % of the composition); an aqueous component; and a third ingredient wherein optionally, the third ingredient is selected from the group consisting of a protein, a second starch, a hydrocolloid and mixtures thereof. In at least some compositions the unmodified starch is used to form a thermally reversible gels.

This specification describes compositions made using a specialty corn starch. In at least some embodiments the compositions are thermally reversible gels.

More specifically, this specification discloses compositions using a corn starch called in specification “aewx corn starch,” which is corn starch obtained from a corn endosperm having three copies (also called doses) of the recessive waxy gene (wx) and two copies of the recessive amylose extender gene (ae). Increased dosage of the wx gene suppresses amylose formation. Being fully recessive for the wx gene the aewx corn starch of this specification has low amylose content compared to common dent corn and may have essentially no amylose. Increased dosage of the ae gene within a waxy starch suppresses branch points in amylopectin resulting in amylopectin having generally increased side chain length. The specific genetic composition of the claimed aewx corn starch was selected for differentiated functionality in the unmodified form compared to unmodified common amylose containing or unmodified waxy corn starch.

Among the functionalities is the ability of its ability to from thermally reversible gels, meaning gels that are solid at ambient temperatures but that melt to form a liquid when reheated and that then solidify again when cooled. The compositions described in this specification are useful in various products, including food products. As further described in this specification the properties of a composition can be further modified with the addition of other ingredients. For example, with reference to thermally reversible gels, compositions may be formulated to have high gel strength in solid form at ambient temperatures, and to form liquids having moderate viscosity when melt. The controlled viscosity of the melted thermally reversible gel is useful for controlling the melt spread of the gel.

### BRIEF DESCRIPTION OF THE FIGURES

The technology disclosed in this specification can be better understood with reference to the FIGURES which are not intended to limit the full scope of the invention.

FIG. 1 is a graph plotting changes in the viscous (G″) and elastic nature (G′) for compositions made using unmodified aewx corn starch over varying temperature.

In one aspect the aewx corn starch disclosed in this specification provide differentiated functionality compared to other corn starches because of its differentiated amylopectin structure. As background amylopectin is one of the two polysaccharides in starch, the other being amylose. Amylopectin has a backbone 1-4 connected glycosides. Side chains of different glycosidic length (different degrees of polymerization) that branch from the backbone at 1-6 connections. The distribution of amylopectin side chain lengths differs based botanical sources so that side chain length distribution can be used distinguished to distinguish starch type.

So, while primarily this specification refers to the starch as an unmodified aewx corn starch (describing the starch by the genotype of the corn endosperm), in another aspect, the corn starch described in this specification can be identified by reference to the distribution of branch chain lengths of the amylopectin. In any embodiment, the compositions and methods described in this specification comprise an unmodified corn starch comprising an amylopectin fraction having a percent fraction of glycoside chains having a degree of polymerization (“DP”) between 25 and 36 of from about 17% to about 22%, or from about 18% to about 20% wherein. In any embodiment, the compositions and methods described in this specification comprises an amylopectin fraction has distribution of a glycoside chains having an average DP from about 23 to about 26, or from about 23 to about 25. In any embodiment, the compositions and methods described in this specification comprises an amylopectin fraction having a percent fraction of glycoside chains having DP greater than 37 of from about 14% to about 18% or from about 15% to about 17%.

In another aspect this specification discloses use aewx corn starch (or corn starches having the branch chain length distribution described) to form thermal reversible gelling composition when used as described in this specification. In any embodiment of a composition described in this specification the unmodified aewx corn starch is in an amount in a of at least about 0.1% (wt % of the gel) or at least about 1% at least about 3%, or at least about 5%, or at least about 7% or at least about 9%. In other embodiments the unmodified aewx corn starch is in an amount of at most about 25% or at most about 20%, or at most about 18% or at most about 16%. In at least some embodiments a composition comprises an unmodified aews starch in a range selected from the group consisting of: a) from about 0.1% to about 3%; b) from about 3% to about 9%; and c) from about 9% to about 20%.

In any embodiment described in this specification, a composition comprising an unmodified aewx corn starch also comprises an aqueous component is in amount in a range from at least about 20% (wt. % of the composition) to about 95%, or from at least about 30% to about 95%, or from about 40%, to about 95%. In any embodiment, the aqueous component is in an amount from 20% (wt. %) to about 95%, or from about 20%, to about 80%, or from about 20% to about 70%, or from about 20% to about 60%. In at least some embodiments the aqueous component is in an amount from about 40% to about 60%.

In embodiments where the third ingredient in a composition comprising an unmodified aewx corn starch is a protein, the protein may be used in various amounts. In any embodiment the protein is in an amount of at least about 0.1% (wt. %) or at least about 1%, or at least about 3% or at least about 5% or at least about 7% or at least about 9%, or at least about 11%. In other embodiments the protein is in an amount of at most about 25% (wt. %), or at most about 20%, or at most about 17%, or at most about 15%, or at most about 13%. In some embodiments composition comprises a protein in an amount in a range selected from the group consisting of a) about 0.1% (wt. %) to about 5%; b) about 5% (wt. %), or about 8% or about 10% or to about 15% and c) about 15% (wt. %) to about 25% or to about 20%.

Any useful proteins may be used in compositions described in this specification. In some embodiments the protein is provided at least in part by a plant protein. A preferred plant protein is a potato protein. Other plant proteins include are pulse protein (also called legume proteins). While any pulse protein may be used preferred pulse proteins are selected from the group consisting of chickpea protein, lentil protein, pea protein, fava bean protein and mixtures thereof. More preferred pulse proteins are pea protein and fava bean protein. In at least some embodiments the compositions described in this specification do not comprise an animal protein.

Other embodiments of the compositions comprising an unmodified aewx corn starch described in this specification do comprise an animal protein. In some embodiments of the compositions described in this specification at least some of the protein within the composition is casein.

In embodiments of the compositions described in this specification where the third ingredient is a second starch, the second starch is any starch other than an unmodified aewx corn starch. In any embodiment described in this specification a second starch is used in an amount from at least about 1% (wt. %), or from at least about 2%, or from at least about 3% up to about 20%. In any embodiment described in this specification a second starch is used in an amount from about 1% to about 15%, or to about 10%, or to about 9%, or to about 7%. In any embodiment described in this specification a second starch is used in an amount from about 1% to about 5%.

In embodiments of the compositions comprising unmodified aewx corn starch described in this specification, useful second starches include (but are not limited to) corn starch, tapioca starch, rice starch, potato starch, pea starch, sago starch, high amylose corn starch, waxy corn starch, waxy tapioca starch, waxy rice starch, waxy potato starch, and mixtures thereof. In at least some embodiments the second starch is a potato starch. The second starches used in composition described in this specification may be a modified starch or may be unmodified starch. If modified starches are used, useful modifications include oxidation, acid hydrolysis, acetylation, hydroxypropylation, crosslinking, thermal inhibition, annealing, enzymatic digestion, and octenylsuccinic acid modification (also called OSA-modified starch). Some modified starches useful in the compositions described in this specification hydroxypropylated and acetylated starches. Other compositions described in this specification preferable use hydrolyzed starch (also called converted starch) wherein the starch is converted by acid or enzyme. Another preferred modified starch is oxidized starch. Still another modified starch is an OSA-modified starch.

Some embodiments, while using a modified starch, do not use a starch that is hydrolyzed, for example by acid, or enzyme. Hydrolysis is a common method for making a gelling starch, although such starches do not form thermal reversible gels.

In any embodiment of the compositions described in this specification where the third ingredient is a hydrocolloid, useful hydrocolloids include xanthan gum, gellan gum, gum Arabic, carrageenan, tara gum, konjac, locust bean gum and mixtures thereof.

In at least some embodiments the compositions comprising unmodified aewx corn starch the composition is a thermally reversible gels. In any embodiment described in this specification a composition, which a thermally reversible gel is formulated to have controlled melt spread when reheated. In any embodiment described in this specification, a thermally reversible gel has a melt spread of greater than 10%, or greater than about 15%, or greater than about 20%, or from about 10%, or from about 12% or from about 14% or from about 16%, or from about 18% to about 20%.

In any embodiment of a composition described in this specification, the composition is a thermally reversible gel that when solid is firm enough to shredded with a cheese grater. In any embodiment described in this specification, a composition is formulated to a have a defined gel firmness. In at least some embodiments a composition has a firmness of greater than about 5,000 g, or greater than about 6,000 g. In some embodiments a composition described in this specification has firmness from about 5,000 g, or from about 5,500 g, or from about 6000 g to about 10,000 g. Other compositions have firmness in a range from about 5,000 g to about 9,000 g, or to 8,500 g, to about 8000 g, or to about 7,500 g, or to about 7,000 g.

In at least some embodiments the composition described in this specification is an imitation cheese product. Imitation cheese described in this specification may be formulated to resemble any desirable cheese products, but in at least some embodiments the imitation cheese has good melt stretch. In any embodiment of an imitation cheese described in this specification, the imitation cheese has a melt stretch of at least about 3 cm, or at least about 5 cm. In at least some embodiments an imitation described in this specification comprises no animal products or is a vegan imitation cheese. In other embodiments of an imitation cheese described in this specification the imitation cheese comprises casein or a dairy product. In embodiments comprising casein, an imitation cheese product, as described in this specification further comprises unmodified aewx corn starch is in an amount from about 1% (wt. %), or about 3%, about 5%, to about 10%, or in an amount from about 1%, or from about 3% or from about 5% up to about 7%.

In embodiments of the composition that comprise casein (for example an imitation cheese). In compositions using casein, it may be in amount in a range from at least about 5% (wt. %) or from at least about 7% or from at least about 11% up to about 20%, from at least about 5% (wt. %) or from at least about 7% or from at least about 11% or up to about 17%, or from at least about 5% (wt. %) or from at least about 7% or from at least about 11% up to about 15%, or up to about from at least about 5% (wt. %) or from at least about 7% or from at least about 11% up to about 13%.

This specification also describes food composition comprising the thermal reversible gel as described in any embodiment in this specification. The food compositions as used in this specification include the thermally reversible gel and at least one other ingredient that is separate from the gel. In any embodiment of a food composition described in this specification thermally reversible gel is a filing within the food composition, or a toping on the composition. In any embodiment described in this specification a food composition is selected from the group consisting of baked goods, cakes, pastries, breads, rolls, meat products, sausages, alternative meat products, extended meat products, pizzas.

This specification also describes, and in any embodiment, covers use of an unmodified aewx corn starch to obtain a thermally reversible gel as described in any foregoing embodiment. In any embodiment in this specification an unmodified aewx corn starch is used in an imitation cheese, which, optionally, does not comprise animal protein.

This specification also describes methods for making thermally reversible gels. In any embodiment of making a thermally reversible gel comprises mixing a unmodified aewx corn starch, an aqueous component, protein, and an ingredient selected from the group consisting of a protein, a second starch, a hydrocolloid and mixtures thereof, heating the mixture to obtain a smooth mass; and cooling the mixture to form the thermally reversible gel. The method can be used to make any embodiment of a thermally reversible gel described in this specification. In at least some embodiments, a thermally reversible gel described in this specification further comprises grinding, cutting or shredding the thermally reversible gel.

Other useful ingredient for the disclosed edible composition follow.

In any embodiment, an edible composition as described in this specification further comprises a sweetener. Useful sweeteners include honey, allulose, tagatose, fructose, glycerol, sucrose, rebaudiosides (A, B, M, etc. and blends thereof), and glucosylated stevia glycosides, corn syrups including high fructose corn syrups. Sweeteners may be provided in solid, or powdered, or liquid, or syrup form.

In any embodiment, an edible composition as described in this specification further comprises a fiber. Useful fibers may include cellulosic fibers from any botanical source, resistant starches, soluble fibers such as polydextrose or short chain fructooligosacchardies.

In any embodiment, an edible composition as described in this specification further comprises a gum or gum-like material. Useful gums and gum like materials include gelling starches, gum Arabic, xanthan gum, tara gum, konjac, carrageenan, locust bean gum, gellan gum, guar gum, pectin, and modified celluloses like carboxymethyl cellulose, and mixtures thereof.

In any embodiment, an edible composition comprising a deamidated legume protein isolate described in this specification useful fats include oils including vegetable oils such as corn oil, olive oil, canola oil, sunflower oil, rapeseed oil, palm oil, coconut oil.

Useful fats (other than vegetable oils) included animal fats and dairy fats. Most preferably the fat is a diary fat or butter fat which may be provided like cow's milk or cow's milk cream of desired fat content.

Useful aqueous ingredients include water, milk (including non-fat milk), syrups, juices from fruits or vegetables, fruit or vegetable purees, or other carbohydrate containing liquids, or acidic liquids, or basic liquids.

In any embodiment, an edible composition comprising a deamidated legume protein isolate described in this specification may further comprises various other flavorings and coloring commonly used in edible composition. In various embodiments of the method the unmodified aewx corn starch may be provided as a pre-cooked, but otherwise unmodified starch. In other embodiments of the method the unmodified aewx corn starch is cooked as part of the method. In any embodiment described a method for making a composition comprising an unmodified aewx starch comprises mixing an unmodified aewx corn starch, an aqueous component, protein, and an ingredient selected from the group consisting of a protein, a second starch, a hydrocolloid and mixtures thereof, optionally heating the mixture; and optionally allowing the mixture to form the thermally reversible gel.

The subject matter described in this specification can be better understood with reference to the following definitions, testing methods, and guidance for construing the terms in this specification.

Reference in this specification to an “aewx corn starch” means a starch from the endosperm of a corn seed containing a genotype comprising three copies of a recessive waxy gene (wx) and two copies of a recessive amylose extender gene (ae). The genotype of an endosperm from which an aewx corn starch, as defined in this specification, is obtained may also be referred to as wxwxwxaeaeAE.

Reference in this specification to “aqueous component” means a component comprising water regardless of its phase (solid, liquid, gaseous, etc.). Aqueous components may comprise other ingredients which are suspended, dispersed, dissolved, or otherwise mixed in the aqueous component. Aqueous components have various pH. Non-limiting examples of aqueous components are water (whether in liquid form, as steam, or as ice), milk, juice, puree, syrup, acidic liquids like vinegar, alkaline liquids, and similar ingredients.

This specification refers to the degree of polymerization of amylopectin branch chains. The measurements were taken using the following method. Starch samples were added to a mixture containing 90% DMSO and 10% water. The mixture was heated in a boiling water bath under moderate stirring. The samples were then removed from the heat and continued to mix at room temperature overnight. Reagent alcohol was added to each sample to precipitate starch. The starch was then collected via centrifugation. The pellets from each starch sample were diluted in water and cooked in a boiling water bath to ensure full dispersion of the starch. Isoamylase was added to each sample for debranching under the specified pH and temperature conditions for the enzyme. Debranched enzyme samples were then filtered and loaded into the DIONEX ICS-3000 system for analysis.

A gradient elution profile consisting of sodium hydroxide and sodium nitrate was used for chain length separation. A degree of polymerization (“DP”) 1-7 solution was used as a peak retention time standard. Samples were integrated for peak area using Chromeleon software. Average branch chain length of starch samples was calculated from the molecular number average. Triplicate samples and duplicate injections for each sample were averaged.

Reference in this specification to “imitation cheese” means a composition meant to imitate cheese. In non-limiting embodiments, of imitation cheese may include non-imitation cheese (in the sense of the imitation cheese comprising as part of its formula a non-imitation cheese, but a whole does not meet the definition of non-imitation cheese), meaning a food composition meeting any one of the various standards of identity for cheese worldwide. Imitation cheese can differ from non-imitation cheese by supplementing the milk in non-imitation cheese or replacing at least some of the milk in non-imitation cheese with one or more other ingredients including but not limited to non-fat milk-solids, starch, gums, casein, non-diary proteins, non-dairy fats or vegetable fats, for example vegetable oil. The term imitation cheese includes compositions comprising casein (but not necessarily deriving a dairy source) as source of protein in the composition and includes vegetarian or vegan compositions that do not comprise any milk protein or other animal product. Imitation cheese may be low protein and may not comprise protein or may comprise protein from a plant source.

Reference in this specification to a “melt spread” means the amount a thermally reversible gel spreads during melting. Any test to measure melt spread may be used, however, melt spread measurements reported in this specification were taken using the following test. A sample of thermally reversible gel was obtained having a 35.5 mm diameter and 5 mm height. Samples were melted in a covered Pyrex petri dish (100×15 mm) atop an aluminum plate by baking in an oven for 5 minutes at 450° F. (about 232° C.). Change in diameter of sample before and after baking using were measured using calipers. Melt spread is reported as a percent change in diameter of the sample before and after melting.

Reference in this specification to “melt stretch” means how much a portion of an embodiment of a melted thermally reversible gel stretches when lifted from a surface by a fork without breaking. Any test to measure melt stretch may be used, however, melt stretch measurements reported in this specification were taken using the following test. A thermally reversible gel was grated over a pizza-like food composition comprising dough crust and tomato sauce ((25 g), thermally reversible gel (80 g). Food composition as baked at 240° C. until thermally reversible gel melted (about 5 to 9 minutes) and then cool the composition at ambient temperature for 3 minutes. Insert a fork inserted into the melted thermally reversible gel and lift fork to create a strand of the melted thermally reversible gel. Melt stretch is reported in centimeters and is the maximum length of the strand before breaking.

Reference in this specification to a “unmodified starch” including unmodified aewx starch includes gelatinized starch, granular starch, and partially gelatinized starch and mixtures thereof, but excludes starch that has been otherwise modified chemically, enzymatically or physically. A non-exhaustive list of chemical modifications excluded from the definition of unmodified starch includes hydropropylated starches, acetylated starches, acid hydrolyzed starches, starches crosslinked with phosphate or adipate moieties, octenylsuccinic modified starches, and oxidized starches. A non-exhaustive enzymatic reactions that are excluded from the definition of unmodified digestion at the 1-4 glycosidic linkage and digestion at the 1-6 glycosidic linkage. A non-exhaustive list of physically modified starches excluded from the definition of unmodified include, for example, shear or use of heat treatment done so that the starch retains its granular structure of the starch (which can be determined by observing a birefringent diffraction pattern when viewing the starch under polarized light) like thermal inhibition, annealing.

Firmness measurements were made using a TAXTII Plus texture analyzer according to the following method. Test samples were stored at refrigeration temperature (about 4° C.) and were removed from refrigeration immediately before testing. TAXTII Plus Texture Analyzer was equipped with a 30 kg load cell and 25 mm diameter aluminum probe (Texture Technologies Product code: TA-25). The probe is advanced 10 mm at a speed of 8 mm/s for a time of 2 seconds and into the sample. Measurements are recorded after a trigger force of 10 grams.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

Ranges used herein present a set of minimum values, designated from at least about, and a set of maximum values, designated up to about and should interpreted to be able to pair any minimum with any maximum recited. For example a range saying an amount in a range from at least about 1 or from at least about 2 up to about 10 or up to about 9 should be interpreted to recited from about 1 to about 10, 1 to about 9, 2 to about 10, and 2 to about 9.

While certain embodiments have been illustrated and described a person with ordinary skill in the art, after reading the foregoing specification, can effect changes, substitutions of equivalents and other types of alterations to the methods, and of the present technology Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification is further described by reference to the following aspects, which are provided for illustrative purposes and are not intended to limit the full scope of technology disclosed.

1 A composition comprising:
a. an unmodified aewx corn starch in an amount of a least about 0.1% (wt. % of the composition);
b. an aqueous component; and
c. a third ingredient wherein optionally, the third ingredient is selected from the group consisting of a protein, a second starch, a hydrocolloid and mixtures thereof
wherein, optionally, the composition is a thermally reversible gel.

2 The composition of claim 1 wherein the unmodified aewx corn starch is in an amount in a of at least about 0.1% (wt % of the gel) or at least about 1% at least about 3%, or at least about 5%, or at least about 7% or at least about 9%.

3 The composition of claim 1 or 2 wherein the unmodified aewx corn starch is in an amount of at most about 25% or at most about 20%, or at most about 18% or at most about 16%

4 The composition of any one of claims 1 to 3 wherein the unmodified aewx corn starch is in an amount from about 0.1% to about 3% (wt. %).

5 The composition of any one of claims 1 to 3 wherein the unmodified aewx corn starch is in an amount from about 3% to about 9%; and

6 The composition of any one of claims 1 to 3 wherein the unmodified aewx corn starch is in an amount from about 9% to about 20%.

7 The composition of any one of claims claim 1 to 6 wherein the protein is in an amount of at least about 0.1% (wt. %), or at least about 1%, or at least about 3%, or at least about 5%, or at least about 7%, or at least about 9%, or at least about 11%.

8 The composition of any one of claims 1 to 7 wherein the protein is in an amount of at most about 25% (wt. %), or at most about 20%, or at most about 17%, or at most about 15%, or at most about 13%.

9 The composition of any one of claims 1 to 8 wherein the protein is in an amount in a range selected about 0.1% (wt. %) to about 5%.

10 The composition of any one of claims 1 to 8 wherein the protein is in an amount in a range selected about 5% (wt. %), or about 8% or about 10% or to about 15%.

11 The composition of any one of claims 1 to 8 wherein the protein is in an amount in a range selected about 15% (wt. %) to about 25% or to about 20%.

12 The composition of any one of claims 1 to 11 wherein the aqueous component is in amount in a range from at least about 20% (wt. % of the composition) to about 95%, or from at least about 30% to about 95%, or from about 40%, to about 95%, or from about 20% to about 95%, or from about 20%, to about 80%, or from about 20% to about 70%, or from about 20% to about 60%, or from about 40% to about 60%.

13 The composition of any one of claims 1 to 12 wherein the protein content is provided at least in part by a plant protein,
wherein, optionally, the plant protein is selected from the group consisting of pulse protein and potato protein and mixtures thereof.

14 The composition of any one of claims 1 to 13 wherein the protein content is at least partially provided by a potato protein.

15 The composition of any one of claims 1 to 14 wherein the protein content is at least partially provided by a pulse protein selected from the group consisting of chickpea protein, lentil protein, pea protein, fava bean protein and mixtures thereof
wherein, preferable, the pulse protein is a pea protein or fava bean protein or mixture thereof,
wherein, more preferably, the pulse protein is a fava bean protein.

16 The composition of any one of claims 1 to 15 wherein the composition does not comprise an animal protein.

17 The composition of any one of claims 1 to 16 wherein the hydrocolloid is selected from the group consisting of xanthan gum, gellan gum, gum Arabic, carrageenan, tara gum, konjac, locust bean gum and mixtures thereof.

18 The composition of any one of claims 1 to 17 wherein the second starch is selected from the group consisting of corn starch, tapioca starch, rice starch, potato starch, pea starch, sago starch, high amylose corn starch, waxy corn starch, waxy tapioca starch, waxy rice starch, waxy potato starch, and mixtures thereof.

19 The composition of any one of claims 1 to 18 wherein the second starch is an unmodified starch.

20 The composition of any one of claims 1 to 19 wherein the second starch is a modified starch wherein the modification is selected from the group consisting of oxidation, acid hydrolysis, acetylation, hydroxypropylation, crosslinking, thermal inhibition, annealing, enzymatic digestion, octenylsuccinic acid modification and mixtures thereof.

21 The composition of any one of claims 1 to 20 wherein the second starch is potato starch.

22 The composition of any one of claims 1 to 21 wherein the second starch is in an amount in a range selected from the group consisting of
a. from at least about 1% (wt. %), or from at least about 2%, or from at least about 3% up to about 20%,
b. from about 1% to about 15%, or to about 10%, or to about 9%, or to about 7%, and
c. from about 1% to about 5%.

23 The composition of any one of claims 1 to 22 wherein the composition is a thermally reversible gel composition.

24 The composition of any one of claims 1 to 23 wherein, the composition is a thermally reversible gel and wherein, when solid, the gel can be shredded with a cheese grater.

25 The composition of any one of claims 1 to 24, wherein the composition is a thermally reversible gel and wherein when solid, the gel has a firmness of greater than about 5,000 g, or greater than about 6,000 g, or from about 5,000, or from about 5,500 g, or from about 6,000 g to about 10,000 g, or from about 5,000 g to about 9,000 g, or to 8,500 g, to about 8000 g, or to about 7,500 g, or to about 7,000 g.

26 The composition of any one of claims 1 to 25, wherein the composition is a thermally reversible gel, and wherein the gel, when melted, has a melt spread of greater than 10%, or greater than about 15%, or greater than about 20%, or in a range from at least about 10%, from at least about 12% or from at least about 14% or from at least about 16%, or at least from about 18%, up to about 20%.

27 The composition of any one of claims 1 to 26 wherein the composition is a thermally reversible gel having a melt stretch of at least about 3 cm, or at least about 5 cm, or up to about 10 cm.

28 The composition of any one of claims 1 to 27 wherein the composition is an imitation cheese product wherein, optionally, the imitation cheese product is vegan.

29 The composition of any one of claims 1 to 28 wherein at least a portion of the protein is casein and wherein the unmodified aewx corn starch is in an amount in a range from at least about 1% (wt. %), or at least about 3%, or at least about 5%, up to about 10%, or in an amount from about 1%, or from about 3% or from about 5% up to about 7%.

30 The composition of any one of claims 1 to 29 wherein at least part of the protein is casein and wherein the casein is in amount in a range from at least about 5% (wt. %) or from at least about 7% or from at least about 11% up to about 20%, from at least about 5% (wt. %) or from at least about 7% or from at least about 11% or up to about 17%, or from at least about 5% (wt. %) or from at least about 7% or from at least about 11% up to about 15%, or up to about from at least about 5% (wt. %) or from at least about 7% or from at least about 11% up to about 13%.

31 A method of making a thermally reversible gelling composition comprising:
a. mixing an unmodified aewx corn starch, an aqueous component, protein, and an ingredient selected from the group consisting of a protein, a second starch, a hydrocolloid and mixtures thereof;
b. optionally, heating the mixture; and
c. allowing the mixture to form the thermally reversible gel.

32 The method of claim 31 wherein the unmodified aewx corn starch is in an amount in a of at least about 0.1% (wt % of the gel) or at least about 1% at least about 3%, or at least about 5%, or at least about 7% or at least about 9%.

33 The method of claim 31 or 32 wherein the unmodified aewx corn starch is in an amount of at most about 25% or at most about 20%, or at most about 18% or at most about 16%.

34 The method of any one of claims 31 to 33 wherein the unmodified aewx corn starch is in an amount or in a range from about 0.1% to about 3%.

35 The method of any one of claims 31 to 34 wherein the unmodified aewx corn starch is in an amount or in a range from about 3% to about 9%.

36 The method of any one of claims 31 to 35 wherein the unmodified aewx corn starch is in an amount or in a range from about from about 9% to about 20%.

37 The method of any one of claims 31 to 36 wherein the protein is in an amount of at most about 25% (wt. %), or at most about 20%, or at most about 17%, or at most about 15%, or at most about 13%.

38 The method of any one of claims 31 to 37 wherein the protein is in an amount in a range selected from about 0.1% (wt. %) to about 5%.

39 The method of any one of claims 31 to 38 wherein the protein is in an amount in a range selected from about 5% (wt. %), or about 8%, or about 10%, or to about 15%.

40 The method of any one of claims 31 to 39 wherein the protein is in an amount in a range selected from about 15% (wt. %) to about 25%, or to about 20%.

41 The method of any one of claims 31 to 40 wherein the aqueous component is in amount in a range from at least about 20% (wt. % of the composition) to about 95%, or from at least about 30% to about 95%, or from about 40%, to about 95%, or from about 20% to about 95%, or from about 20%, to about 80%, or from about 20% to about 70%, or from about 20% to about 60%, or from about 40% to about 60%.

42 The method of any one of claims 31 to 41 wherein the protein content is provided at least in part by a plant protein,
wherein, optionally, the plant protein is selected from the group consisting of pulse protein and potato protein and mixtures thereof.

43 The method of any one of claims 31 to 42 composition of any one of claims 1 to 6 wherein the protein content is at least partially provided by a potato protein.

44 The method of any one of claims 31 to 43 wherein the protein content is at least partially provided by a pulse protein selected from the group consisting of chickpea protein, lentil protein, pea protein, fava bean protein and mixtures thereof
wherein, preferable, the pulse protein a pea protein or fava bean protein or mixture thereof,
wherein, more preferably, the pulse protein is a fava bean protein.

45 The method of any one of claims 31 to 44 wherein the gel does not comprise an animal protein.

46 The method of any one of claims 31 to 45 wherein the hydrocolloid is selected from the group consisting of xanthan gum, gellan gum, gum Arabic, carrageenan, tara gum, konjac, locust bean gum and mixtures thereof.

47 The method of any one of claims 31 to 46 wherein the second starch is selected from the group consisting of corn starch, tapioca starch, rice starch, potato starch, pea starch, sago starch, high amylose corn starch, waxy corn starch, waxy tapioca starch, waxy rice starch, waxy potato starch, and mixtures thereof.

48 The method of any one of claim 31 to 47 wherein the second starch is an unmodified starch.

49 The method of any one of claim 31 to 48 wherein the second starch is a modified starch wherein the modification is selected from the group consisting of oxidation, acid hydrolysis, acetylation, hydroxypropylation, crosslinking, thermal inhibition, annealing, enzymatic digestion, octenylsuccinic acid modification and mixtures thereof.

50 The method of any one of claims 31 to 49 wherein the second starch is potato starch.

51 A composition comprising:
a. an unmodified corn starch in an amount of a least about 0.1% (wt. % of the composition);
b. an aqueous component; and
c. a third ingredient wherein optionally, the third ingredient is selected from the group consisting of a protein, a second starch, a hydrocolloid and mixtures thereof
wherein the composition is a thermally reversible gel.

52 The composition of claim 51 wherein the unmodified corn starch is in an amount in a of at least about 0.1% (wt % of the gel) or at least about 1% at least about 3%, or at least about 5%, or at least about 7% or at least about 9%.

53 The composition of claim 51 or 52 wherein the unmodified corn starch is in an amount of at most about 25% or at most about 20%, or at most about 18% or at most about 16%.

54 The composition of any one of claims 51 to 53 wherein the unmodified corn starch is in an amount from about 0.1% to about 3% (wt. %).

55 The composition of any one of claims 51 to 54 wherein the unmodified corn starch is in an amount from about 3% to about 9%; and

56 The composition of any one of claims 51 to 55 wherein the unmodified corn starch is in an amount from about 9% to about 20%.

57 The composition of any one of claims claim 51 to 56 wherein the protein is in an amount of at least about 0.1% (wt. %), or at least about 1%, or at least about 3%, or at least about 5%, or at least about 7%, or at least about 9%, or at least about 11%.

58 The composition of any one of claims 51 to 57 wherein the protein is in an amount of at most about 25% (wt. %), or at most about 20%, or at most about 17%, or at most about 15%, or at most about 13%.

59 The composition of any one of claims 51 to 58 wherein the protein is in an amount in a range selected about 0.1% (wt. %) to about 5%.

60 The composition of any one of claims 51 to 59 wherein the protein is in an amount in a range selected about 5% (wt. %), or about 8% or about 10% or to about 15%.

61 The composition of any one of claims 51 to 60 wherein the protein is in an amount in a range selected about 15% (wt. %) to about 25% or to about 20%.

62 The composition of any one of claims 51 to 61 wherein the aqueous component is in amount in a range from at least about 20% (wt. % of the composition) to about 95%, or from at least about 30% to about 95%, or from about 40%, to about 95%, or from about 20% to about 95%, or from about 20%, to about 80%, or from about 20% to about 70%, or from about 20% to about 60%, or from about 40% to about 60%.

63 The composition of any one of claims 51 to 62 wherein the protein content is provided at least in part by a plant protein,
wherein, optionally, the plant protein is selected from the group consisting of pulse protein and potato protein and mixtures thereof.

64 The composition of any one of claims 51 to 63 wherein the protein content is at least partially provided by a pulse protein selected from the group consisting of chickpea protein, lentil protein, pea protein, fava bean protein and mixtures thereof
wherein, preferable, the pulse protein is a pea protein or fava bean protein or mixture thereof,
wherein, more preferably, the pulse protein is a fava bean protein.

65 The composition of any one of claims 51 to 64 wherein the composition does not comprise an animal protein.

66 The composition of any one of claims 51 to 65, wherein the composition is a thermally reversible gel and wherein when solid, the gel has a firmness of greater than about 5,000 g, or greater than about 6,000 g, or from about 5,000, or from about 5,500 g, or from about 6,000 g to about 10,000 g, or from about 5,000 g to about 9,000 g, or to 8,500 g, to about 8000 g, or to about 7,500 g, or to about 7,000 g.

67 The composition of any one of claims 51 to 66, wherein the composition is a thermally reversible gel, and wherein the gel, when melted, has a melt spread of greater than 10%, or greater than about 15%, or greater than about 20%, or in a range from at least about 10%, from at least about 12% or from at least about 14% or from at least about 16%, or at least from about 18%, up to about 20%.

68 The composition of any one of claims 51 to 67 wherein the composition is a thermally reversible gel having a melt stretch of at least about 3 cm, or at least about 5 cm, or up to about 10 cm.

69 The composition of any one of claims 51 to 68 wherein the composition is an imitation cheese product
wherein, optionally, the imitation cheese product is vegan.

70 The composition of any one of claims 51 to 69 wherein at least a portion of the protein is casein and wherein the unmodified corn starch is in an amount in a range from at least about 1% (wt. %), or at least about 3%, or at least about 5%, up to about 10%, or in an amount from about 1%, or from about 3% or from about 5% up to about 7%.

71 The composition of any one of claims 51 to 70 wherein the composition does not comprise a modified gelling starch.

72 A method of making a thermally reversible gelling composition comprising:
a. mixing an unmodified corn starch, an aqueous component, protein, and an ingredient selected from the group consisting of a protein, a second starch, a hydrocolloid and mixtures thereof;
b. optionally, heating the mixture; and
c. allowing the mixture to form the thermally reversible gel.

73 The method of claim 72 wherein the unmodified corn starch is in an amount in an of at least about 0.1% (wt % of the gel) or at least about 1% at least about 3%, or at least about 5%, or at least about 7% or at least about 9%.

74 The method of claim 72 or 73 wherein the unmodified corn starch is in an amount of at most about 25% or at most about 20%, or at most about 18% or at most about 16%.

75 The method of any one of claims 72 to 74 wherein the unmodified corn starch is in an amount or in a range from about 0.1% to about 3%.

76 The method of any one of claims 72 to 75 wherein the unmodified corn starch is in an amount or in a range from about 3% to about 9%.

77 The method of any one of claims 72 to 76 wherein the unmodified corn starch is in an amount or in a range from about from about 9% to about 20%.

78 The method of any one of claims 72 to 77 wherein the protein is in an amount of at most about 25% (wt. %), or at most about 20%, or at most about 17%, or at most about 15%, or at most about 13%.

79 The method of any one of claims 72 to 78 wherein the protein is in an amount in a range selected from about 0.1% (wt. %) to about 5%.

80 The method of any one of claims 72 to 79 wherein the protein is in an amount in a range selected from about 5% (wt. %), or about 8%, or about 10%, or to about 15%.

81 The method of any one of claims 72 to 80 wherein the protein is in an amount in a range selected from about 15% (wt. %) to about 25%, or to about 20%.

82 The method of any one of claims 72 to 81 wherein the aqueous component is in amount in a range from at least about 20% (wt. % of the composition) to about 95%, or from at least about 30% to about 95%, or from about 40%, to about 95%, or from about 20% to about 95%, or from about 20%, to about 80%, or from about 20% to about 70%, or from about 20% to about 60%, or from about 40% to about 60%.

83 The method of any one of claims 72 to 82 wherein the protein content is provided at least in part by a plant protein,
wherein, optionally, the plant protein is selected from the group consisting of pulse protein and potato protein and mixtures thereof.

84 The method of any one of claims 72 to 83 wherein the protein content is at least partially provided by a pulse protein selected from the group consisting of chickpea protein, lentil protein, pea protein, fava bean protein and mixtures thereof
wherein, preferable, the pulse protein a pea protein or fava bean protein or mixture thereof,
wherein, more preferably, the pulse protein is a fava bean protein.

85 The method of any one of claims 72 to 84 wherein the gel does not comprise an animal protein.

86 The method of any one of claims 72 to 85 wherein the second starch is potato starch.

87 The method of any one of claims 72 to 86 wherein the method does not comprise adding a modified gelling starch.

88 The composition or method of any foregoing wherein the unmodified corn starch or unmodified aewx corn starch comprises an amylopectin fraction having a percent fraction of glycoside chains having a degree of polymerization (“DP”) between 25 and 36 of from about 17% to about 22%, or from about 18% to about 20% wherein.

89 The composition or method of any foregoing wherein the unmodified corn starch or unmodified aewx corn starch comprises an amylopectin fraction has distribution of a glycoside chains having an average DP from about 23 to about 26, or from about 23 to about 25.

90 The composition or method of any foregoing wherein the unmodified corn starch or unmodified aewx corn starch comprises an amylopectin fraction having a percent fraction of glycoside chains having DP greater than 37 of from about 14% to about 18% or from about 15% to about 17%.

91 A food composition comprising the thermal reversible gel as described in any foregoing claim and a second edible ingredient.

92 The food composition of claim 91 wherein the thermally reversible gel is a filing within the food composition or a toping on the composition.

93 The food composition as described in claim 91 or 92 being selected from the group consisting of baked goods, cakes, pastries, breads, rolls, meat products, sausages, analog meat products, extended meat products, and pizzas.

94 Use of an unmodified corn starch or unmodified aewx corn starch to obtain a thermally reversible gel as described in any foregoing claim.

95 Use of an unmodified corn starch or an unmodified aewx corn starch as recited in claim 94 in an imitation cheese, optionally wherein the imitation cheese does not comprise animal protein.

The technology disclosed in this specification is further described by reference to the following examples, which are provided for illustrative purposes and are not intended to limit the full scope of technology disclosed.

### Example 1—Thermal Reversible Gel Using Unmodified Aewx Corn Starch

A custard-like composition modeled on flan was made to demonstrate the thermal reversible nature of gels obtainable using unmodified aewx corn starch.

TABLE 1
Formulation of Flan-like Composition.

| Ingredient | % |
|---|---|
| Full fat milk 3.5% fat | 75.28 |
| Cream 32% | 9 |
| Non-fat dry milk powder | 0.6 |
| Sugar | 10 |
| Starch Component | 5 |
| Vanilla flavour (note type & | 0.08 |
| batch) | |
| Colour (ß-carotine) | 0.04 |
| total: | 100 |

Three samples were made using a starch component comprised of one or more starches. Sample 1 used 100% thermally inhibited starch. Sample 2 used a mixture 80% to 20% of thermally inhibited starch and unmodified aewx corn starch. Sample 3 used a 50% to 50% mixture of thermally inhibited starch and unmodified aewx corn starch.

Flan was made as follows. Sugar, starch, and dry milk powder were pre-blended and added to milk and some cream (to prevent foaming). Milk mixture was mixed at with high speed/shear mixer (Ultra Turrax/Silverson) at 10,000 RPM until homogenous. The rest of the cream was added and hand mixed. Mixture was let sit for 30 minutes and transferred to an in-line heat exchanger. Mixtures was cooked using an in-line processing heat exchanger (ASEPTO, tube set up). Mixture was preheated to 60° C. and then homogenized in a two-stage homogenizer using 100 bar on first stage and 30 bar on second stage. The product was then sterilized for 68 second at 130° C. (temperature ramp for 34 sec). Mixture was cooled to around from 87° C. and placed in beakers. Beakers were further cooled in a blast chiller and mixture was stored at 4° C. for 14 days until tested for thermoreversibility.

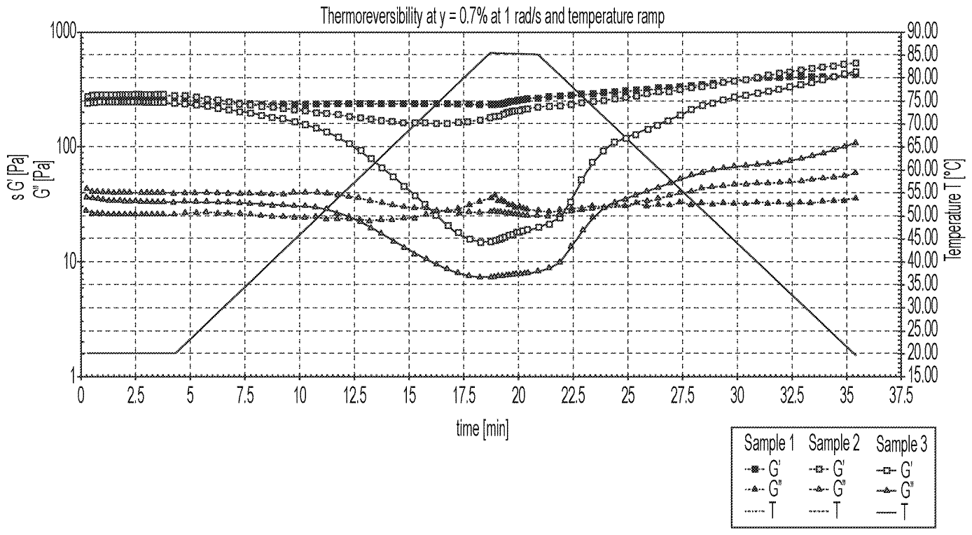

Thermal reversible nature of the gels made using unmodified aewx corn starch is illustrated in FIG. 1, which plots changes in the storage modulus (G′), describing the elastic nature of the material and the loss modulus (G″) describing the viscous nature of the material as it is heated. The oscillatory measurements were taken with an Anton Paar rheometer (MCR 702) using a 25 mm plate-plate geometry at pre-identified linear viscoelastic regime of the tested samples (at constant shear deformation of 0.41% and constant angular frequency of 1 radians/s). At the constant conditions, the samples were equilibrated to 20° C. and afterwards the lower plate was heated to 85° C. (4.3° C./min.) and kept at 85° C. for 2 min. Then the lower plate was cooled down to 20° C. (4.3° C./min.). In FIG. 1, temperature changes are depicted by the solid line with actual temperature plotted in linear scale on the secondary y-axis (° C., right side of the graph). The loss modulus and storage modulus (both in Pa) are plotted in logarithmic scale on the primary the y-axis (left side). Time, in minutes, is plotted on the x-axis. As seen, Sample 1 (thermally inhibited starch) experiences essentially no change in the loss modulus or storage modulus. Sample 4 using 50% unmodified aewx corn starch shows a significant loss in the storage modules as the material is heated, with subsequent recovery of the storage modulus as the material cools again. This demonstrates the thermal reversible nature of gels made using unmodified aewx corn starch as the material shift from elastic character to more viscous character back to a more elastic character with temperature.

### Example 2—Melt Spread of Imitation Cheese

Imitations cheeses were made using various starches and evaluated for melt spread. All starches used were dent corn, unmodified aewx corn starch, waxy potato, potato, pea. All starches were in unmodified form. Processing and nutritional values of all batches were matched to obtain proper comparative results.

Five batches of imitation cheese were made according to the formula reported in Table 2, varying only the unmodified starch used among the batches. Batch 1 used dent corn starch. Batch 2 used unmodified aewx corn starch. Batch 3 used waxy potato starch. Batch 4 used potato starch. Batch 5 used pea starch.

TABLE 2
Imitation Cheese Formulation

| Ingredients | Wt % |
|---|---|
| Mild White Cheddar Cheese | 60.00 |
| Non-Fat Dry Milk | 3.40 |
| Water | 21.36 |
| Unmodified aewx corn starch | 5.00 |
| Palm Fat | 7.40 |
| Emulsifying Salt | 2.50 |
| Salt | 0.34 |
| TOTAL | 100.00 |

The nutritional information for imitation cheese, as formulated in Table 3, is reported in Table 3. Also, the imitation cheese has a moisture content of 53.69%.

TABLE 3
Nutritional Information

| Nutritional Information | Wt % |
|---|---|
| % Protein | 16.13 |
| % Sugar | 2.00 |
| % Salt | 1.99 |
| % Fat | 27.09 |

Shredded mild white cheddar cheese, fat, and dry ingredients were blended obtain a homogenous mass. Water was added to hydrate the mass, which was then heated to 180° F. (about 82° C.) and held at that temperature until a uniform mass that was pourable and smooth was formed (about 10 minutes). The cooked cheese mass was dispensed into heat resistant storage containers and transferred immediately to storage at 40° F. (about 4° C.).

Imitation cheese was evaluated for melt spread using a melt spread test. A cheese borer (35.5 mm diameter) was used to isolate a cheese sample having height of 5 mm. Cheese samples were placed in a covered Pyrex petri dish (100×15 mm) atop an aluminum plate and baked in an over for 5 minutes at 450° F. (about 232° C.). The average diameter of each cheese sample was measured before and after baking using calipers. Each sample was evaluated in duplicate. Results are reported as average % change in the diameter of a sample (before heating and after heating). Results are reported in Table 4.

TABLE 4
Melt spread results

| Batch | Spread (% change) |
|---|---|
| Batch 1 (dent corn) | 9.44% |
| Batch 2 (aewx corn) | 19.97% |
| Batch 3 (waxy potato) | 3.53% |
| Batch 4 (potato) | 0.60% |
| Batch 5 (pea) | 1.18% |

### Example 3—Melt Stretch of Vegan Imitation Cheese

Vegan analog cheese was made using various amounts of unmodified aewx corn starch. Formulas are provided Table 5.

TABLE 5
Formulations of Vegan Analog Cheese
Using Unmodified Corn Starch

| Ingredient | Sample 8 (wt %) |
|---|---|
| Water | 44.60 |
| Vegetable shortening | 30.00 |
| Hydrocolloid mix* | 6.00 |
| Unmodified aewx Corn | 15.00 |
| starch | |
| Cheese flavor | 1.50 |
| Salt | 1.20 |
| Yeast extract | 0.80 |
| Potassium sorbate | 0.05 |
| Color | 0.03 |
| Lactic acid | 0.10 |
| TOTAL | 100.00 |

Simplistica™ DY 7211 available from Ingredion Incorporated

Vegan analog cheese of this example was designed to mimic a mozzarella-style dairy pizza cheese. The vegan analog cheese was made as follows. All ingredients except lactic acid were added mixed at high-speed mixing (˜900 rpm) for 2 minutes using a thermal mixer (Stephan UM/SK5 with direct steam injection). Mixing continued and the mixture was heated to and held at 86° C. for 1 minute. Lactic acid was then added, and mixing continued for 15 seconds. Hot mixture was transferred to molds and cooled in a blast chiller to solidify.

Vegan analog cheeses were made in blocks that were shredded and placed on a pizza (dough crust, tomato sauce (25 g), shredded vegan imitation cheese (80 g)). Pizzas were cooked at 240° C. (conventional oven) for a time from 5 to 9 minutes until cheese appeared completely melted. Pizzas were then allowed to cool at ambient temperatures for 3 minutes. Melt stretch was evaluated by placing a fork in the cheese and pulling away from the pizza. Maximum length before breaking of melted strings of the were measured. Sample had melt stretch from 3 cm to 10 cm when measured in duplicate.

### Example 4—Physical Attributes of Corn Starch

Attributes of amylose-containing corn starches and waxy corn starches are compared to the unmodified aewx corn starch are reported in the tables below.

Particle size: Starch particle size distribution was measured in powder form using a Malvern Mastersizer 3000 particle size analyzer. All samples were analyzed in triplicate. Table 6 reports the mode diameter for corn starch granules averaged over the three measurements. Waxy corn starch is common amylose free corn starch. Dent corn is common amylose containing corn starch. The unmodified aewx corn starch Samples 1 to 3 are from three separate milling campaigns from the same harvest of unmodified aewx corn kernels.

TABLE 6
Particles Sizes of Various Corn Starches
Corn starch particle size distribution (powder)

| Sample | Average mode (μm) |
|---|---|
| Waxy corn starch | 17.55 |
| Dent corn starch | 15.44 |
| unmodified aewx | 10.53 |
| corn starch Sample 1 | |
| unmodified aewx | 13.05 |
| corn starch Sample 2 | |
| unmodified aewx | 11.96 |
| corn starch Sample 3 | |

Particle size distribution indicates that the average granule diameter of unmodified aewx corn starch is smaller than waxy corn starch and dent corn starch.

Average branch chain length of starch samples was calculated from the molecular number average using ion exchange chromatography as the method of branch chain length separation.

“Debranching method:” The following starch debranching method was used to calculated degree of polymerization of starch branch chains. Starch samples were added to a mixture containing 90% DMSO and 10% water. The mixture was heated in a boiling water bath under moderate stirring. The samples were then removed from the heat and continued to mix at room temperature overnight. Reagent alcohol was added to each sample to precipitate starch. The starch was then collected via centrifugation. The pellets from each starch sample were diluted in water and cooked in a boiling water bath to ensure full dispersion of the starch. Isoamylase was added to each sample for debranching under the specified pH and temperature conditions for the enzyme. Debranched enzyme samples were then filtered and loaded into the DIONEX ICS-3000 system for analysis.

A gradient elution profile consisting of sodium hydroxide and sodium nitrate was used for chain length separation. A degree of polymerization (“DP”) 1-7 solution was used as a peak retention time standard. Samples were integrated for peak area using Chromeleon software. Average branch chain length of starch samples was calculated from the molecular number average. Triplicate samples and duplicate injections for each sample were averaged. Results are reported in Table 7.

TABLE 7
Branch Chain Distribution of Various Starch

| | Percent distribution | | | | Average |
|---|---|---|---|---|---|
| Sample | 6-12 | 13-24 | 25-36 | ≥37 | DP |
| Waxy corn | 19.5 ± 0.3 | 49.3 ± 1.3 | 18.4 ± 0.3 | 12.8 ± 1.0 | 22.2 ± 0.3 |
| starch | | | | | |
| unmodified | 16.5 ± 0.6 | 47.4 ± 0.6 | 19.6 ± 0.3 | 16.6 ± 1.0 | 24.1 ± 0.3 |
| aewx corn | | | | | |
| starch | | | | | |
| Sample 1 | | | | | |
| unmodified | 16.8 ± 0.8 | 46.3 ± 2.4 | 19.3 ± 0.4 | 17.6 ± 2.4 | 24.4 ± 1.0 |
| aewx corn | | | | | |
| starch | | | | | |
| Sample 2 | | | | | |
| unmodified | 15.8 ± 1.0 | 46.2 ± 1.8 | 20.0 ± 0.5 | 18.0 ± 2.2 | 24.7 ± 1.0 |
| aewx corn | | | | | |
| starch | | | | | |
| Sample 3 | | | | | |

The average DP of unmodified aewx corn starch samples is approximately two glucose units longer than waxy corn starch. Average DP and chain length distribution is very similar for all batches.

Gelatinization temperature was identified using differential scanning calorimetry (DSC). starch slurry was made and heated so that the starch was gelatinized. A 3:1 ratio of water:starch was added to stainless steel pans. The pans were sealed and added to a Perkin Elmer DSC programed to fully gelatinize the starch. Gelatinization peaks were integrated using ThemoCline DSC software which calculated onset, peak, and end gelatinization temperature, as well as enthalpy change.

Results are reported in Table 8. The unmodified aewx corn starch had a higher onset, peak, and end gelatinization temperature than waxy corn starch. The unmodified aewx corn starch had onset gelatinization about 2° C. higher than waxy corn starch. Without being bound by theory, the longer branch chain length of unmodified aewx corn starch (in comparison to waxy corn starch) likely contributes to the higher observed gelatinization temperature. All unmodified aewx corn starches isolated have similar onset, peak, and end gelatinization temperatures.

TABLE 8
Gelatinization Profile of Starch

| Sample | Onset (° C.) | Peak (° C.) | End (° C.) | ΔH (J/g) |
|---|---|---|---|---|
| Waxy corn starch | 65.1 ± 0.3 | 71.9 ± 0.2 | 78.7 ± 0.5 | 17.8 ± 0.3 |
| unmodified aewx | 67.0 ± 0.7 | 74.3 ± 0.5 | 82.7 ± 0.5 | 17.4 ± 0.4 |
| corn starch Sample 1 | | | | |
| unmodified aewx | 66.4 ± 0.2 | 73.4 ± 0.0 | 82.5 ± 0.1 | 16.7 ± 0.2 |
| corn starch Sample 2 | | | | |
| unmodified aewx | 67.2 ± 0.2 | 74.1 ± 0.2 | 81.0 ± 0.1 | 17.0 ± 1.3 |
| corn starch Sample 3 | | | | |

Microscopy of starch cooks: samples of gelatinized starch were collected and were mixed with 80 μL of 0.1N iodine solution for staining. One to three drops of solution (starch, water and iodine) were pipetted onto a glass slide before mounting on the light microscope (Nikon Eclipse 80i) stage at 400× magnification. Images of the sample were taken at three different regions on the slide. Images are provided in FIG. 1. Images of unmodified aewx corn starch pastes show swollen, intact granules, and large granule fragments. Waxy corn starch, in contrast, showed small granule fragments. Higher gelatinization temperature (Table 8) coupled with granule integrity after cooking (FIG. 1) indicates that native unmodified aewx corn starch requires more harsh processing to fragment during cooking.

Retrogradation stability was tested by storing the sealed pans from gelatinization measurement in the refrigerator for one week at 4° C. to induce retrogradation. The pans were then added to the DSC which ran the gelatinization program a second time to measure the enthalpy required to break the bonds formed during retrogradation. The average enthalpy measurement of the second scan was divided by the average enthalpy measurement for first scan (obtained during granule gelatinization) to compare retrogradation percentage or stability between samples.

Results from retrogradation stability testing are reported in Table 9. The unmodified aewx corn starch had a lower retrogradation stability than waxy corn starches.

TABLE 9
Retrogradation Stability of Waxy Corn Starch

| Sample | Retrogradation (%) | | |
|---|---|---|---|
| Waxy corn starch | 42.9 | ± | 1.0 |
| unmodified aewx | 44.2 | ± | 1.2 |
| corn starch Sample 1 | | | |
| unmodified aewx | 47.9 | ± | 0.8 |
| corn starch Sample 2 | | | |
| unmodified aewx | 48.1 | ± | 0.4 |
| corn starch Sample 3 | | | |

Unmodified aewx corn starch has more retrogradation than waxy corn starch. This shows that unmodified aewx corn starch tends to form firmer compositions over time, which is a trait that can be used to provide differentiated texture compared to starches from other sources.

1. A composition comprising:
a. an unmodified aewx corn starch in an amount of a least about 0.1% (wt. % of the composition);
b. an aqueous component; and
c. a third ingredient wherein optionally, the third ingredient is selected from the group consisting of a protein, a second starch, a hydrocolloid and mixtures thereof.

2. The composition of claim 1 wherein the unmodified aewx corn starch is in an amount of at least about 0.1% (wt % of the gel).

3. The composition of claim 1 wherein the unmodified aewx corn starch is in an amount of at most about 25%.

4-17. (canceled)

18. The composition of claim 1 wherein the second starch is selected from the group consisting of corn starch, tapioca starch, rice starch, potato starch, pea starch, sago starch, high amylose corn starch, waxy corn starch, waxy tapioca starch, waxy rice starch, waxy potato starch, and mixtures thereof.

19. The composition of claim 1 wherein the second starch is an unmodified starch.

20. The composition of claim 1 wherein the second starch is a modified starch wherein the modification is selected from the group consisting of oxidation, acid hydrolysis, acetylation, hydroxypropylation, crosslinking, thermal inhibition, annealing, enzymatic digestion, octenylsuccinic acid modification and mixtures thereof wherein, preferably, the modification is thermal inhibition.

21. The composition of claim 1 wherein the second starch, preferably, is selected from the group consisting of potato starch, waxy corn starch, waxy tapioca starch, waxy rice starch.

22. The composition of claim 1 wherein the second starch is in an amount in a range selected from the group consisting of
a. from at least about 1% (wt. %), or from at least about 2%, or from at least about 3% up to about 20%,
b. from about 1% to about 15%, or to about 10%, or to about 9%, or to about 7%, and
c. from about 1% to about 5%.

23. The composition of claim 1 wherein the composition is a thermally reversible gel composition.

24. The composition of claim 1 wherein, the composition is a thermally reversible gel and wherein, when solid, the gel can be shredded with a cheese grater.

25. The composition of claim 1, wherein the composition is a thermally reversible gel and wherein when solid, the gel has a firmness of greater than about 5,000 g.

26. The composition of claim 1, wherein the composition is a thermally reversible gel, and wherein the gel, when melted, has a melt spread of greater than 10%.

27. The composition of claim 1, wherein the composition is a thermally reversible gel having a melt stretch of at least about 3 cm.

28. The composition of claim 1, wherein the composition is an imitation cheese product wherein, optionally, the imitation cheese product is vegan.

29. The composition of claim 1, wherein at least a portion of the protein is casein and wherein the unmodified aewx corn starch is in an amount in a range from at least about 1% (wt. %).

30. The composition of claim 1, wherein at least part of the protein is casein and wherein the casein is in amount in a range from at least about 5% (wt. %).

31. A method of making a thermally reversible gelling composition comprising:
a. mixing an unmodified aewx corn starch, an aqueous component, protein, and an ingredient selected from the group consisting of a protein, a second starch, a hydrocolloid and mixtures thereof;
b. optionally, heating the mixture; and
c. allowing the mixture to form the thermally reversible gel.

32-87. (canceled)

88. The composition of claim 1, wherein the unmodified corn starch or unmodified aewx corn starch comprises an amylopectin fraction having a percent fraction of glycoside chains having a degree of polymerization (“DP”) between 25 and 36 of from about 17% to about 22%.

89. The composition of claim 1, wherein the unmodified corn starch or unmodified aewx corn starch comprises an amylopectin fraction having distribution of a glycoside chains having an average DP from about 23 to about 26.

90. The composition claim 1, wherein the unmodified corn starch or unmodified aewx corn starch comprises an amylopectin fraction having a percent fraction of glycoside chains having DP greater than 37 of from about 14% to about 18%.

91-95. (canceled)
